(19) United States
(12) Patent Application Publication
(10) Pub. No.: US 2004/0055805 A1
(43) Pub. Date: Mar. 25, 2004

(54) Impact sensor

(76) Inventors: Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 10/620,962

(22) Filed: Jul. 15, 2003

(30) Foreign Application Priority Data
Jul. 16, 2002 (DE) 102 32 053.5

(51) Int. Cl. B60R 21/00

(52) U.S. Cl. 180/274

(57) ABSTRACT

An impact sensor is proposed, which includes a compressible medium, which changes it conductivity as a function of the compression, the impact sensor, as a function of the change in the conductivity, emitting a signal that is indicative of a parameter characteristic of an impact.

### FIELD OF THE INVENTION

The present invention relates to an impact sensor.

### SUMMARY OF THE INVENTION

The impact sensor according to the present invention has the advantage that through the use of a compressible medium that changes its conductivity as a function of the compression a sensor may be utilized, which is easy to integrate in the vehicle body, the bumper or the side of the vehicle. Using conductive foamed plastic as the compressible material is especially advantageous insofar as, in addition to the foamed plastic that is utilized in any event in the bumper, for instance, no additional sensors need to be integrated as sensing element. It may be provided in this context that the conductive foamed plastic be used in addition to, or instead of, the usual foamed plastic. Conductive foamed plastic has the further advantage of allowing large-area sensing, for instance by the bumper, in an uncomplicated manner. Unnecessary additional sensor units may be dispensed with and also their synchronization and the processing of the signals in a control device. In the case of side sensing, too, large-area sensing may be carried out instead of the point-by-point sensing as it is known from acceleration sensors. Furthermore, such a compressible material as the impact sensor is installed at the outermost point of the vehicle and could constitute a time advantage in the triggering of a restraining device as the actuator system.

It is especially advantageous that the compressible material, preferably the conductive foamed plastic, is installed both in the front and in the rear bumper. Here, the foamed plastic, which is installed anyway, is preferably simply switched for a conductive foamed plastic. In this way, no additional expenditure and effort are required for the integration of the impact sensor according to the present invention, since the manufacturing processes may be essentially adopted.

The impact sensor according to the present invention may also be used as side-impact sensor in an advantageous manner. In this case, the foamed plastic is preferably accommodated in the decorative trim, but it is also possible to use other moldings for the installation of the impact sensor.

In particular, the sensor according to the present invention may be used to detect a pedestrian impact. As a function of the detection of such an impact, a restraining device of the type used for pedestrians may be employed as well.

### BRIEF DESCRIPTION OF THE DRAWINGS

FIG. 1 shows a first block diagram of the impact sensor according to the present invention.

FIG. 2 shows a second block diagram of the impact sensor according to the present invention.

FIG. 3 shows the impact sensor according to the present invention in a bumper, prior to, and following, an impact.

### DETAILED DESCRIPTION

A large number of concepts are currently utilized, especially with regard to protecting pedestrians, both in the field of sensing and in actuator technology. For the most part, bumper sensors are used for detecting a pedestrian impact. Force sensors or deformation sensors are employed in this connection, which extend across the entire width of the vehicle inside the bumper. Examples of such force sensors are piezo-foils, strain gauges, optical waveguide sensors or sensors of composite. Some of the deformation sensors are also optical waveguides or simple switches. In some cases, a plurality of sensors is used to detect the impact location. For protection, airbag systems are essentially integrated in the engine compartment, or else the engine hood is raised in order to counteract the impact of the person in an appropriate manner. Many methods are known in the field of side sensing to detect side crashes, these including pressure and acceleration sensors, optical sensors and other sensor principles, which are all located on the inside of the door, however.

The integration of new sensory systems in a bumper presents certain problems. The current design of bumpers uses foamed plastic which, provided with a plastic coat, is mounted on the vehicle suspension. According to the present invention, this foamed plastic for an impact sensor for the front and the rear is now exchanged for a conductive foamed plastic. This conductive foamed plastic has the special characteristic of changing its conductance in response to compression. This is advantageous inasmuch as, apart from using the foamed plastic as the actual sensing element, it does not require the integration of additional sensors. As represented above, this conductive foamed plastic with its connected electronic system may be used as an impact sensor for side sensing as well. In this case, the foamed plastic may preferably be accommodated in the decorative trim.

Thus, the essence of the present invention is the use of a conductive foamed plastic as sensor element in the bumper, both in the front and the rear bumper. In this case, the foamed plastic in bumpers, which is currently used for impact damping, is replaced by the conductive foamed plastic. Alternatively, it is possible for the conductive foamed plastic to be used in combination with a non-conductive foamed plastic, thereby producing a bumper-foamed plastic sensor unit, which may be utilized for sensing in connection with pedestrian protection or other collisions. Thus, the specific advantage is the exchange of an existing component for a new one, i.e., the simple integration in the bumper it allows.

An additional advantage is the large-area sensing of the bumper, which means that unnecessary additional sensor units may be dispensed with and likewise their synchronization and the processing of incoming signals. The contacting occurs between the front and back side of the foamed plastic. The electric resistance is the actual characteristic (quantity) here, which is reduced under a compressive load. Similar advantages result in the example for side sensing. The sensing is carried out over large areas and not only point-by-point. Furthermore, the sensor is likewise located at the outermost point of the vehicle, which may result in a time advantage in the triggering of the actuator technology. The utilized foamed plastic, as compressible material, thus changes its conductivity in response to compression of this material. Such a foamed plastic may be produced, for example, by introducing graphite particles into the foamed plastic. A spray procedure may be used for this purpose, for instance, in that a layer of foamed plastic is applied first, followed by a thin layer of graphite particles, and then by another layer of foamed plastic onto which a further layer of graphite particles is applied. The graphite particles are diffused into the foamed plastic by a subsequent heat treatment. When the foamed plastic is compressed, the graphite particles are contacted, so that the resistance drops with the compression. When no compression takes place, depending on the concentration of the graphite particles, no, or only a low, current can flow between the sides of the foamed plastic. This will depend on whether the graphite particles, given a lack of compression, allow a current to flow through the foamed plastic. By an appropriate distribution of the graphite particles or some other conductive particles inside the foamed plastic, it is also possible to embody a switch, which allows conduction beginning with a particular compression, but which will not permit a current flow below such compression. However, other manufacturing methods and configurations for the conductive foamed plastic are possible as well. Specifically, it is also possible to use only the change in resistance as a measure for a side impact, or for impact detection in general. Instead of foamed plastic, other compressible materials that may be induced to conduct an electrical current at least through compression are conceivable as well.

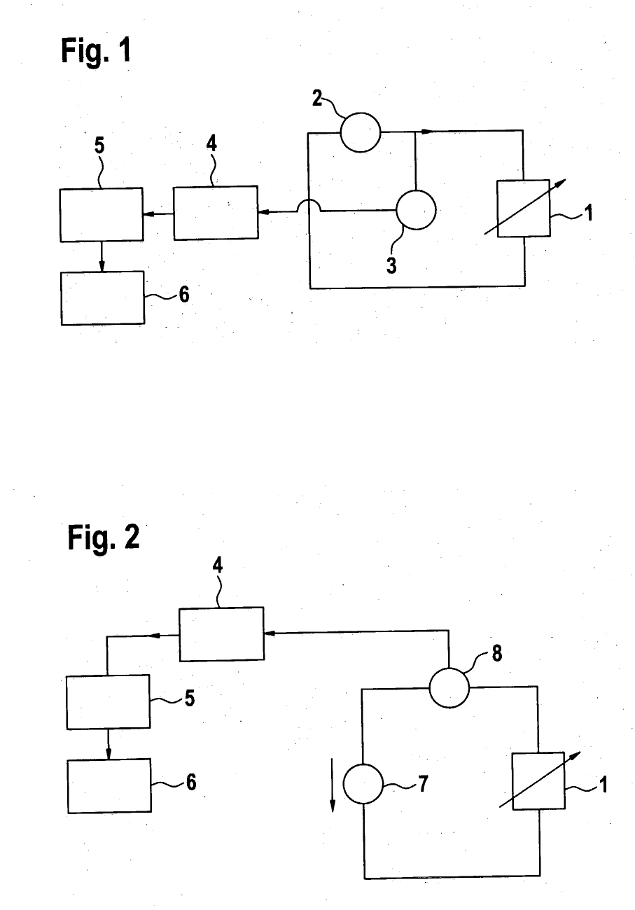

In a block diagram, FIG. 1 shows a first exemplary embodiment of an impact sensor according to the present invention. A compressible material 1, which exhibits conductivity at least in response to compression and for this reason is represented as a variable resistor, is connected at one end to a current source 2 and a voltmeter 3. On the other side of conductive material 1, it is also connected to the other pole of current source 2 and voltmeter 3. Via a data output, voltmeter 3 is connected to a measuring amplifier and analog-digital converter 4, which, by way of a data output, is in turn connected to a processor 5, such as a micro-controller, which is connected to restraining device 6 via a data output.

Resistor 1 changes its conductivity as a function of the compression to which is subjected. Since current source 2 drives a constant current through resistor 1, a change in the resistance value of resistor 1 leads to a change in the voltage drop across this resistor 1, this voltage drop being recorded by voltmeter 3. This value is then transmitted from voltmeter 3 to the measuring amplifier with analog-digital converter 4, which amplifies this value and converts it into a digital value. Processor 5 processes this digital value, especially in a triggering algorithm, so as to detect a crash as a function thereof, and, if appropriate, to deploy restraining device 6, such as airbags or belt tighteners. In this example, the measuring amplifier and digital-analog converter is embodied as an impact sensor together with current source 2, voltmeter 3 and resistor 1. In addition, this impact sensor includes a transmitter component (not shown here), which transmits the digital value measured at resistor 1 to processor 5. Preferably, a power-line transmission is used for this purpose, i.e., a d.c. current is transmitted from processor 5 to the impact sensor via this line, which connects the impact sensor to processor 5, the current being used to supply energy to the components of the impact sensor. The transmitter component (not shown) modulates its data onto this d.c. current in order to transmit it to processor 5, either in the form of a unidirectional or a bi-directional transmission. Furthermore, a bus connection may exist between processor 5 and the impact sensor. Another alternative is that all components, including processor 5, are accommodated in a housing and only restraining device 6 are triggered via an interface. For the sake of simplicity, the ignition-circuit control has been omitted here. The ignition-circuit control is used to fire restraining device 6 and may be accommodated in the housing with the other components as well.

FIG. 2 shows an alternative measuring concept. Here, resistor 1 is switched in parallel to a voltage source 7, an ampere meter 8 being arranged in series to voltage source 7 and resistor 1 to measure the current. This ampere meter 8 is connected to measuring amplifier 4 and the analog-digital converter via an output. Measuring amplifier 4 is in turn connected to processor 5, which is in connection with restraining device 6. Here, a fixed voltage is alternatively applied across resistor 1, so that the current flowing through resistor 1 and ampere meter 8 changes as a function of the changing conductivity of resistor 1. This measured current is transmitted to measuring amplifier and analog-digital converter 4 as an analog signal. The then digitized value is transmitted to processor 5, which uses it to calculate its triggering algorithm and to trigger restraining device 6, if appropriate. As an alternative, it is possible, as represented above, that the absolute value or the change in the conductance is not processed in processor 5, but that the impact sensor according to the present invention is embodied as a switch. This means that, starting with a particular conductance, a transistor, for instance, is switched through in order to then signal a crash. However, this does not allow the detailed signal analysis made possible by the impact sensor according to FIG. 1 and FIG. 2. For here the time characteristic of the change in the resistance is able to be analyzed as well. This allows predictions regarding the crash severity and the further crash characteristic. On this basis, an adaptive use of restraining device 6 is then possible. Additional parameters are incorporated in the triggering of restraining device 6, such as data regarding the passengers present in the vehicle and signals from plausibility and other sensors.

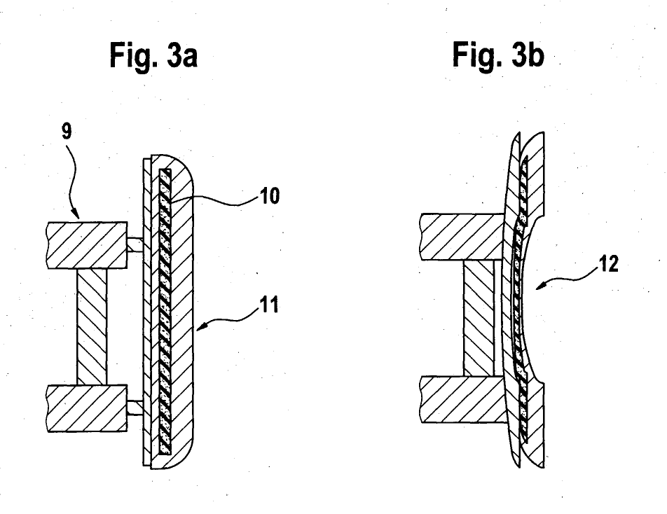

In a schematic view in representation a, FIG. 3 shows a bumper which includes the impact sensor according to the present invention, before a crash and, in Figure b, after a crash. FIG. 3a shows an elongated frame element and crossmember 9 which supports a bumper 11. Bumper 11 has an outer skin, foam 10 and support. FIG. 3b shows the compressed foamed plastic. Compression leads to a change in resistance of the impact sensor, which is transmitted as signal according to the measuring principles in FIG. 1 and FIG. 2, to a control device or an associated processor, for example.

It is possible for the foamed plastic not to be configured as a continuous band, as shown here, but as partial bands.

What is claimed is:

1. An impact sensor, comprising:
a compressible medium that changes its conductivity as a function of a compression; and
an arrangement for emitting, as a function of a change in conductivity, a signal that is indicative of a parameter characteristic of an impact.

2. The impact sensor as recited in claim 1, wherein:
the impact sensor is located in a bumper.

3. The impact sensor as recited in claim 1, wherein:
the impact sensor is affixed on a vehicle side.

4. The impact sensor as recited in claim 3, wherein:
the impact sensor is accommodated in a trim molding on the vehicle side.

5. The impact sensor as recited in claim 3, wherein:
the impact sensor is accommodated in a molding.

6. The impact sensor as recited in claim 1, wherein:
the compressible medium includes a foamed plastic.

7. The impact sensor as recited in claim 6, wherein:
the foamed plastic includes conductive foamed plastic arranged in combination with non-conductive foamed plastic.

8. A method of using an impact sensor including a compressible medium that changes its conductivity as a function of a compression, and an arrangement for emitting, as a function of a change in conductivity, a signal that is indicative of a parameter characteristic of an impact, the method comprising:
using the impact sensor to detect a pedestrian impact.
